(19) United States
(12) Patent Application Publication
(10) Pub. No.: US 2026/0343717 A1
(43) Pub. Date: Oct. 29, 2026

(54) X-RAY SOURCE ASSEMBLY WITH MULTIPLE FILAMENTS

(71) Applicant: KONINKLIJKE PHILIPS N.V., EINDHOVEN (NL)

(72) Inventor: HELMUT MRUSEK, HAMBURG (DE)

(21) Appl. No.: 19/114,601

(22) PCT Filed: Sep. 19, 2023
(86) PCT No.: PCT/EP2023/075718

§ 371 Date: Mar. 24, 2025

(30) Foreign Application Priority Data
Sep. 26, 2022 (EP) 22197800.0

(51) Int. Cl. H05G 1/34; H05G 1/10; H05G 1/60

(52) U.S. Cl. CPC H05G 1/34; H05G 1/10; H05G 1/60

(57) ABSTRACT

The present invention relates to an imaging X-ray source assembly (200) with multiple filaments (FL, FS). The X-ray source assembly comprises a plurality of filaments (FL, FS, FX) configured to emit electrons when a respective current passes through the filament (FL, FS, FX); a filament transformer (T1) configured to transfer electrical energy to the plurality of filaments (FL, FS, FX); a filament driver (FD1) configured to supply electrical energy to the plurality of filaments (FL, FS, FX) via the filament transformer (T1); a plurality of switches (S1, S2, SX) each connected to a respective one of the filaments (FL, FS, FX) and configured to regulate the respective current through the respective filament (FL, FS, FX); and a control unit (CTRL) connected to the plurality of switches (S1, S2, SX) and the filament driver (FD1). The connection between the filament driver (FD1) and the control unit (CTRL) is galvanically isolated. The filament driver (FD1) is configured to provide a filament driver output signal to the control unit (CTRL), and the control unit (CTRL) is configured to control the plurality of switches (S1, S2, SX) by respective switch control signals based on the filament driver output signal.

### FIELD OF THE INVENTION

The invention relates to the field of X-ray, and more specifically to an X-ray source assembly with multiple filaments, to a computer implemented method of controlling multiple filaments, to an imaging system comprising the X-ray source assembly and to an X-ray tube insert configured to be comprised in the X-ray source assembly.

### BACKGROUND OF THE INVENTION

X-ray tubes are used for a variety of medical and industrial imaging processes. An X-ray tube typically includes a cathode with a focusing cup and a filament and a rotating anode. A tube current is applied to the filament, which heats the filament, causing the filament to expel electrons (thermionic emission), creating a space charge (or cloud a negative charge) a short distance away from the filament. A tube voltage is applied across the cathode and the anode and causes a beam of the electrons to accelerate from the cathode and impinge the anode. Sometimes a grid voltage is applied to electrodes of the focusing cup to control a size of and steer the beam of electrons. An interaction of the electrons with the material of the anode produces heat and radiation, including X-rays, which pass through a tube window. Electrical power is supplied to the X-ray tube with a high voltage generator.

A surface area of the anode that receives the beam of electrons is referred to as a focal spot. The size of the focal spot is one factor that affects the image quality of X-ray imaging. For example, the focal spot size affects the spatial resolution, where a smaller focal spot size results in a greater spatial resolution than a larger focal spot size, e.g., due to less focal spot blur from geometric magnification.

Many X-ray tubes available have more than one filament. In order to supply all individual filaments with electrical energy, complex drivers are necessary.

JP5395320B2 describes an X-ray tube equipped with a negative electrode having two filaments having electron emission amounts different from each other, a positive electrode target arranged oppositely to the negative electrode, and emitting an X-ray by hitting electrons emitted from the negative electrode against it, and a vacuum envelope with the negative electrode and the positive electrode target housed therein; and a control part electrically connected to the two filaments, and controlling whether the two filaments should be driven at the same time or not.

U.S. Pat. No. 4,811,375A describes an X-ray tube with a rotatable anode. The X-ray tube comprises a cathode rotatably mounted in the tube envelope and incorporating plurality of cathode filaments. Cathode rotation drive means are provided for rotating the cathode to select the desired filament. The cathode drive means is preferably magnetically coupled through the tube wall in order to rotate the cathode.

The power chain of driving multiple filaments with sufficient speed and performance is relatively complex, costly and space consuming.

### SUMMARY OF THE INVENTION

It is therefore an object of the invention to provide an X-ray source assembly with reduced cost and space required for driving multiple filaments.

The invention is defined by the independent claims. Advantageous embodiments are defined in the dependent claims.

According to a first aspect of the invention, there is provided an imaging X-ray source assembly with multiple filaments, the X-ray source assembly comprising:
a plurality of filaments configured to emit electrons when a respective current passes through the filament;
a filament transformer configured to transfer electrical energy to the plurality of filaments;
a filament driver configured to supply electrical energy to the plurality of filaments via the filament transformer;
a plurality of switches each connected to a respective one of the filaments and configured to regulate the respective current through the respective filament; and
a control unit connected to the plurality of switches and the filament driver.

The connection between the filament driver and the control unit is galvanically isolated. The filament driver is configured to provide a filament driver output signal to the control unit, and the control unit is configured to control the plurality of switches by respective switch control signals based on the filament driver output signal.

The X-ray source assembly makes it possible to drive and control at least two filaments with a single driver and transformer, and thereby reduce complexity of the system. Thanks to this approach, space required for the high voltage generator as well as total cost of components can be decreased. Furthermore, one independent wire instead of at least two is sufficient in the high voltage cable between the X-ray tube and the high voltage generator.

The filament driver controls the total power over the transformer to the filaments and, via the filament driver output signal to the control unit, how the power is divided between the filaments. With one filament driver, the total supplied power and distribution over multiple filaments can thus be rapidly and efficiently controlled. Thanks to the galvanic isolation between the filament driver and the control unit, the filament driver (optionally with at least one processor) may be isolated from the high voltage part, which may make it possible to reduce size and cost of the source assembly.

Galvanic isolation is a principle of isolating functional sections of electrical systems to prevent current flow such that no direct conduction path is permitted. Energy or information can still be exchanged between the sections by other means, such as but not limited to capacitive, inductive, radiative, optical, acoustic, or mechanical coupling.

In an embodiment of the invention, the switch control signals are pulsed control signals, and the control unit is configured to control each of the switches to switch with a duty cycle larger than 0% and less than 100%. The configuration of duty cycle controlled switches in combination with a common filament current set point is advantageous for controlling the multiple filaments with a single driver. With these two variables, common filament current and duty cycle per switch, the effective current of each individual filament can be controlled. The duty cycle of a switch is the fraction of a period during which the switch is active or ON. The duty cycles per switch may be synchronized such that when one switch is ON, the other switch or switches are OFF. Similarly, for switches that may be grouped in sets of switches, when one set of switches is ON, the other sets of switches may be off.

In an embodiment of the invention, the control unit is configured to control at least one of the plurality of switches to switch with a duty cycle larger than 10% and less than 90%.

In an embodiment of invention, the pulsed control signal has a (maximum) pulse length smaller than a characteristic thermal response time of the respective filament. It is advantageous if the pulse length is shorter than a characteristic thermal response time of the filament in order to get a stable temperature of the filament. In this way, filament temperature fluctuations may be reduced or avoided. Duty cycled control of the filament current allows the filament to be kept on a suitable standby temperature. In this way, it can be avoided that the filament cools down too much and the filament can be quickly switched on, to emit electrons, from a standby phase without significant delay due to the thermal response. In other words, fast switching between filaments is enabled. Thermal response time in this context is a measure of how quickly the filament heats up and cools down. It may depend on aspects such as, but not limited to, filament material, purity, dimensions, surrounding vacuum etc. The switching frequency of the pulsed signal may be in an order of magnitude of thousands of Hz, preferably many thousands of Hz, more preferably at least 10 kHz.

In an embodiment of the invention, plurality of switches are semiconductor switches. Such switches are advantageous thanks to their capability of high frequency switching. Semiconductor switches also have low losses. Examples of components for such semiconductor switches include but are not limited to, metal-oxide-semiconductor field-effect transistors, silicon carbide switches, insulated-gate bipolar transistors etc.

In an embodiment of the invention, the X-ray source assembly further comprises an anode configured to generate X-rays when impinged with electrons at a focal spot, wherein a first one of the filaments is configured to emit electrons to impinge a first focal spot on the anode, wherein a second one of the filaments is configured to emit electrons to impinge a second focal spot on the anode, and wherein the second focal spot is different from the first focal spot in size, location and/or shape. Simplified control over multiple filaments according to the invention can advantageously be used with multiple focal spots, where the characteristics of each filament may be optimized to the characteristics of the focal spot. Such as, but not limited to, a large focus filament that emits electrons impinging a large focus focal spot and a small focus filament that emits electrons impinging a small focus focal spot. In X-ray imaging technologies such as computed tomography, fluoroscopy etc. there is sometimes a need to rapidly switch between focal spots. E.g. but not limited to cardiovascular applications. Embodiments of the invention allows for fast switching between the focal spots. In addition, e.g. in combination with grid electrodes or other electron beam optics, the invention may advantageously provide additional flexibility to focal spot control.

In an embodiment of the invention, the control unit is connected to the filament driver via an optical fiber or wireless connection. Such an optical fiber, wireless connection or other galvanically isolated connections makes it possible to e.g. locate the control unit inside and the filament driver outside a high voltage environment of the X-ray source assembly.

In an embodiment of the invention, the power to switch at least one of the switches is derived from windings of the filament transformer. By harvesting power for the switches from the same filament transformer that is used to transfer energy to the filaments, the need for additional power sources to drive the switches can be avoided. Other forms of energy harvesting, such as but not limited to solar, thermal, kinetic energy harvesting are also conceivable.

In an embodiment for the invention, the X-ray source assembly is programmable to control the respective filament currents. This is advantageous as it allows for various protocols to be optimized for the imaging application at hand. In advance and/or during imaging for increased flexibility. A user may interface with the programmable X-ray source assembly via a suitable computer interface and/or via communication channels as part of an imaging system. A programmable part of the X-ray source assembly may advantageously be on a low voltage side of the assembly to reduce complexity on the high voltage side, where space may be limited. Alternatively or in addition, a programmable part may be on a high voltage side close to the switches such that delays can be minimized for very fast switching.

According to a second aspect of the invention, there is provided a computer implemented method of controlling a plurality of filament currents with the programmable X-ray source assembly, the method comprising:
controlling, via the filament driver, supply of electrical energy to the plurality of filaments via the filament transformer; and
controlling, via the control unit, the plurality of switches by the respective switch control signals.

According to a further aspect of the invention, there is a computer program, which, when being executed by a computer, is adapted to cause the X-ray source assembly to carry out the above computer implemented method.

According to a further aspect of the invention, there is a computer readable medium having stored thereon the computer program mentioned above.

According to a third aspect of the invention, there is provided a medical imaging system comprising the X-ray source assembly. The medical imaging system may be a radiography system, a computed tomography system, a fluoroscopy system, a C-arm X-ray system for interventional guidance etc.

According to a fourth aspect of the invention, there is provided an X-ray tube insert configured to be comprised in the X-ray source assembly, wherein the X-ray tube insert comprises the plurality of filaments, wherein the plurality of filaments are configured to be connected to the same filament transformer, and wherein each of the plurality of filaments is configured to be connected the respective one of the plurality of switches.

These and other aspects of the invention will be apparent from and elucidated with reference to the embodiments described hereinafter.

### BRIEF DESCRIPTION OF THE DRAWINGS

FIG. 1 schematically illustrates a conventional multi-filament X-ray source assembly.

FIG. 2 schematically illustrates an X-ray source assembly, according to an embodiment of the invention.

FIG. 3 schematically illustrates a filament driver, according to an embodiment of the invention.

FIG. 4 schematically illustrates a control unit according to an embodiment of the invention.

FIG. 5 schematically illustrates a control unit according to an embodiment of the invention.

FIG. 6 illustrates an example of the relation between transformer current, respective filament current and respective switch control signal, according to an embodiment of the invention.

FIG. 7 schematically illustrates an X-ray source insert, according to an embodiment of the invention.

### DESCRIPTION OF EMBODIMENTS

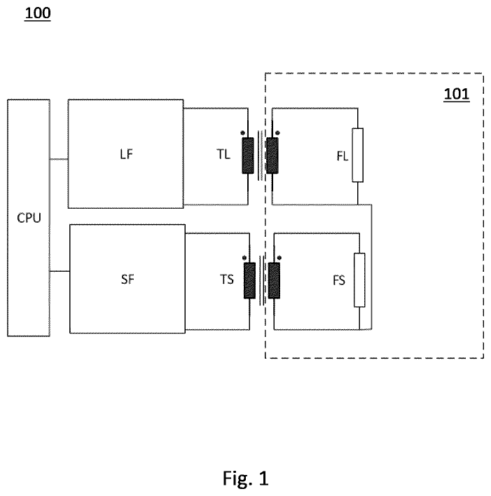

FIG. 1 schematically illustrates a conventional X-ray source assembly 100 (filament driver circuit) with two filaments FL, FS in the high voltage part 101 of the assembly, in a vacuum environment. Each of the filaments FL, FS may be configured to emit electrons via thermionic emission when a tube current is applied to the filament. Such a tube current heats the filament, thereby causing the filament to expel electrons. As described in the background section, the emitted electrons are accelerated from the cathode filament in an electrode beam towards an anode (not shown in the figure) with a tube voltage, thereby causing generation of X-rays at the anode. The filaments FL, FS may be configured to generate focal spots of the same or different size, shape, location etc. on the anode. For example, FL may be suited to generate a large focal spot and FS may be suited to generate a smaller focal spot. Each of the filaments FL, FS in the X-ray source assembly 100 has a corresponding filament driver LF, SF and a corresponding transformer TL, TS. Each filament driver LF, SF is controlled with one or multiple processors CPU, and generates voltage to drive the corresponding filament FL, FS. Each filament transformer TL, TS insulates the high voltage part 101 from the low voltage part and transforms the generated voltage of the corresponding filament driver LF, SF to transfer power to the corresponding filament FL, FS. Although schematically the assembly 100 may look relatively simple, multiple filament drivers LF, SF and transformers TL, TS lead to very bulky and complex structures. The example X-ray source assembly in FIG. 1 has two filaments FL, FS with corresponding drivers LF, SF and transformers TL, TS. However, it is also possible that an X-ray source assembly three or even more sets of filaments, filament drivers and transformers.

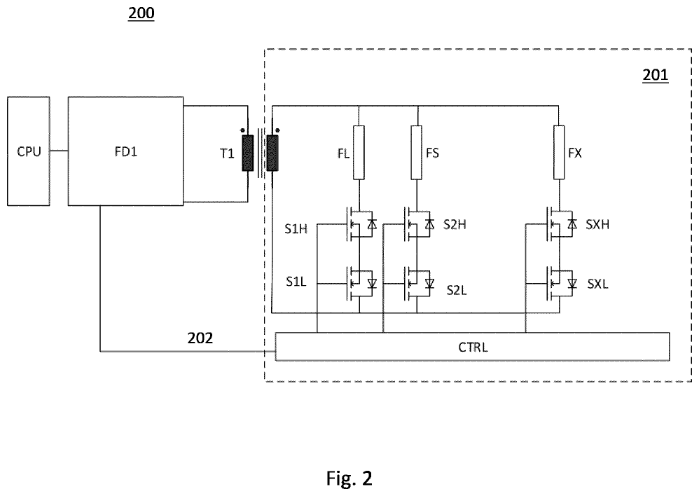

FIG. 2 schematically illustrates an X-ray source assembly 200 (filament driver circuit) according to an embodiment of the invention. The X-ray source assembly 200 comprises multiple, at least two, filaments FL, FS, FX (shown in the figure as resistors). A first filament FL is configured to emit electrons when a current passes through the first filament FL. A second filament FS is configured to emit electrons when a current passes through the second filament FS. The filaments FL, FS may be configured to generate focal spots of the same or different size, shape, location etc. on an anode. For example, FL may be suited to generate a large focal spot and FS may be suited to generate a smaller focal spot. However, FL and FS may also be configured to generate the same or identical focal spots. The X-ray source assembly 200 may also have more filaments, such as an Xth filament FX configured to emit electrons when a current passes through the Xth filament FX. Although the multiple filaments FL, FS, FX, may be configured to generate different focal spots, the X-ray source assembly 200 may also comprise electron beam optics (not shown) to focus/and or steer the electron beam from the filaments FL, FS, FX. The combination of multiple filaments with electron beam optics may provide increased flexibility in focal spot control.

The X-ray source assembly 200 comprises a filament transformer T1 connected to the first filament FL and the second filament FS. Optionally, the filament transformer T1 is also connected to additional filaments FX. The filament transformer T1 is configured to transfer electrical energy to the filaments FL, FS and optionally to additional filaments FX. The X-ray source assembly 200 comprises a filament driver FD1 configured to supply electrical energy to the first filament FL and the second filament FS via the filament transformer T1. Optionally, the filament driver is configured to supply electrical energy to additional filaments FX via the filament transformer T1. The X-ray source assembly 200 comprises a first switch S1 connected to the first filament FL and configured to regulate the current through the first filament FL. The X-ray source assembly 200 comprises a second switch S2 connected to the second filament FS and configured to regulate the current through the second filament FS. Optionally, the X-ray source assembly 200 comprises an Xth switch SX connected to the Xth filament FX and configured to regulate the current through the Xth filament FX. In this example, the switches S1, S2, SX each comprise a high part S1H, S2H, SXH and a low part S1L, S2L, SXL in series. Such switches are advantageous when regulating alternating currents through the filaments. However, other types of switches are also conceivable. The switches may advantageously be semiconductor switches, such as but not limited to, switches comprising metal-oxide-semiconductor field-effect transistors (MOSFET), silicon carbide switches, insulated-gate bipolar transistors etc. The X-ray source assembly 200 also comprises a control unit CTRL. The control unit CTRL is connected to the first switch S1 and the second switch S2 and the filament driver FD1. The control unit CTRL is configured to control the first switch S1 and the second switch S2 with a switch control signal. Optionally, the control unit CTRL is connected to and configured to control an Xth switch, SX.

In the example in FIG. 2, the filaments FL, FS, FX, the switches S1, S2, SX and the control unit CTRL are located on the high voltage side 201 of the X-ray source assembly 200. The filament driver FD1 and processor CPU are located on the low voltage side, insulated from the high voltage part 201 by the transformer T1. The control unit CTRL on the high voltage side 201 is connected to the filament driver FD1 on the low voltage side via an optical fiber 202. Alternatively, the connection may be a wireless connection or other high voltage insulating connection. Everything in the high voltage part 201 as illustrated in FIG. 2 is at the same voltage potential. I.e. at the cathode voltage potential of the X-ray source assembly 200. The multiple filaments may be fed by a secondary winding of the filament transformer T1. By controlling the multiple switches S1, S2, SX and their respective on and off time, the energy provided by the filament driver FD1 can be distributed to the filaments FL, FS, FX. The switches S1, S2, SX and the filaments FL, FS, FX may advantageously be controlled with a pulsed control signal. During the time that one switch is ‘ON, the other switch or switches may be ‘OFF’.

The configuration of duty cycle controlled switches in combination with a common filament current set point is advantageous for controlling the multiple filaments with a single driver. With these two variables, common filament current and duty cycle per switch, the effective current of each individual filament can be controlled. As a non-limiting example with two filaments FL and FS, a set point filament current may be 9.5 A and a duty cycle may be 0.63 for filament FL and 0.37 for filament FS. In this example, filament FL has an effective current of around 6 A and may be emitting electrons, whereas the filament FS has an effective current of around 3.5 A and may be in standby mode. The pulse length of the pulsed control signal may be shorter than a characteristic thermal response time of the filaments FL, FS. In this way duty cycled control of the filament current then allows the filaments to be kept on a suitable standby temperature when off, without cooling down too much. Thus, each filament FL, FS can be quickly switched on, to emit electrons, from a standby phase without significant delay due to the thermal response, thereby enabling fast switching between the filaments FL, FS.

In the example in FIG. 2 the X-ray source assembly 200 comprises one or multiple processors CPU in connection with the filament driver FD1. The X-ray source assembly 200 may therefore be programmable, e.g. programmable to control the currents over the filaments FL, FS, FX. Thus, key parameters for controlling electron emission from either of the multiple filaments, such as filament current set point, duty cycle and pulse length, may be programmed in advance and/or adapted during operation of the X-ray source assembly. It may be particularly advantageous to do all or most processing on the low voltage side, e.g. to reduce complexity and due to the often limited space on the high voltage side 201. However, it is conceivable that there may also be at least some processing and/or programming in the control unit CTRL on the high voltage side 201. This may be advantageous to avoid signal delays to the switches S1, S2, SX. As an example, the control unit CTRL on the high voltage side may comprise a Field-programmable gate array (FPGA) to decode the signals/commands from the filament driver FD1 into duty cycle for the switches S1, S2, SX.

The X-ray source assembly 200 may thus be able to execute a computer program and/or connect to external devices executing such a program. Users may directly or indirectly interact with the X-ray source assembly and/or connected external devices via a user interface. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable user interaction in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

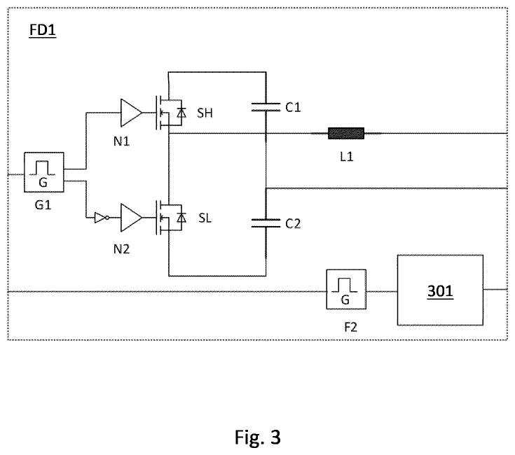

FIG. 3 schematically illustrates an example of a filament driver FD1 in some more detail. The filament driver FD1 is shown here as a half bridge inverter with two MOSFET switches SH and SL. However, the filament driver FD1 may also be implemented using a full bridge inverter or other suitable topologies. In the example in FIG. 3, a pulse generator G1 drives two gate drivers N1 and N2 to control the two MOSFET switches SH and SL. The pulse generator G1 may drive the gate drivers N1 and N2 with a high frequency, preferably a frequency larger than 1 kHz and even more preferably larger than 10 kHz. In this way, the switches SH and SL are controlled to adjust the energy for the high voltage transformer T1. In this example, the inductor L1 forms a resonant circuit together with capacitances C1 and C2. Alternatively or additionally, other circuits without resonant circuit may be used to drive the transformer T1. The fiber optics driver F2 is a frequency generator controlled by a processor CPU. The filament driver output signal from the fiber optics driver F2 goes via a fiber optics converter 301 to the control unit CTRL via a fiber optic connection 202 (not shown here). The filament driver output signal from the fiber optics driver F2 may be a fixed frequency signal with variable pulse-pause ratio or a coded frequency signal which has to be re-encoded on the high voltage side 201. The filament driver FD1 in FIG. 3 thus has two pulse drivers. The pulse generator G1 effectively determines the total power that is transferred over the transformer T1 to the filaments FL, FS, FX. The fiber optics driver F2 controls, via the controller CTRL, how that power is divided between the filaments FL, FS, FX.

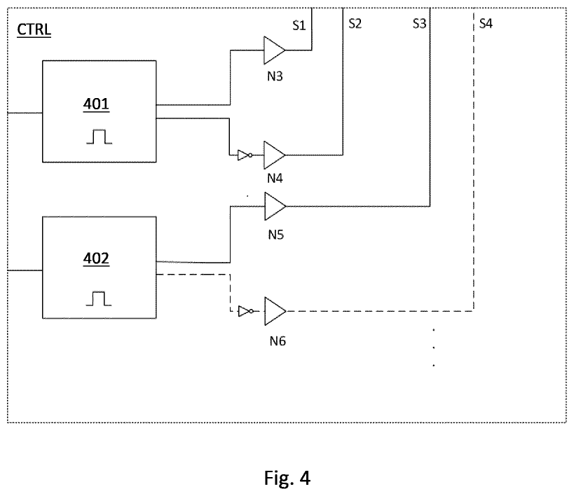

FIG. 4 schematically illustrates an example of a control unit CTRL. In this example, signals from the fiber optics driver F2, via the fiber optics connection 202 enters the control unit CTRL on the left side. The signals are converted into electrical signals by means of fiber optics converters 401, 402. The converted electrical signal is then transmitted to the respective switches S1, S2, S3, S4 via gate drivers N3, N4, N5, N6, here with NOT logic gates at N4 and N6. As illustrated in the figure, this configuration requires multiple fiber optics connections/converters to drive more than two switches S1, S2, S3, S4 and thus to drive more than two filaments. The fiber optics signals for 401 and 402 may need to be synchronized by the CPU in order to distribute the duty cycles or switch on time for S1 to S4. In this example “four-switch configuration” the maximum duty cycle per switch pair (e.g. S1 and S2 or S3 and S4) is 50%. The gate drivers N3, N4, N5, N6 and/or fiber optics converters 401,402 and/or switches S1, S2, S3, S4 may be powered by a separate power supply (not shown), or power can be harvested from the filament transformer T1 or from another form of energy harvesting.

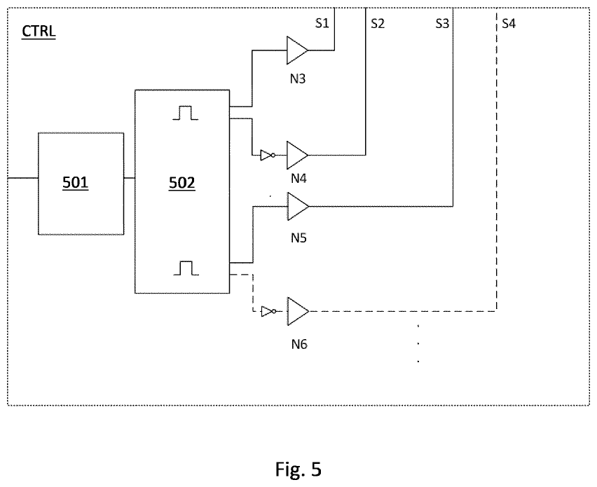

FIG. 5 schematically illustrates another example of a control unit CTRL. In this example a single fiber optics connection 202 and fiber optics converter 501 may be used to drive more than two switches S1, S2, S3, S4 and thus to drive more than two filaments. In this case, the signal from the fiber optics driver F2, communicated via the fiber optics connection 202, and converted to an electric signal by the fiber optics converter 501, is encoded. The signal is decoded by an encoder 502 and passed on to the switches S1, S2, S3, S4 via the gate drivers N3, N4, N5, N6. In this example “four-switch configuration” the maximum duty cycle per switch pair (e.g. S1 and S2 or S3 and S4) is 50%. The gate drivers N3, N4, N5, N6 and/or fiber optics converter 501 and/or encoder 502 and/or switches S1, S2, S3, S4 may be powered by a separate power supply (not shown), or power can be harvested from the filament transformer T1.

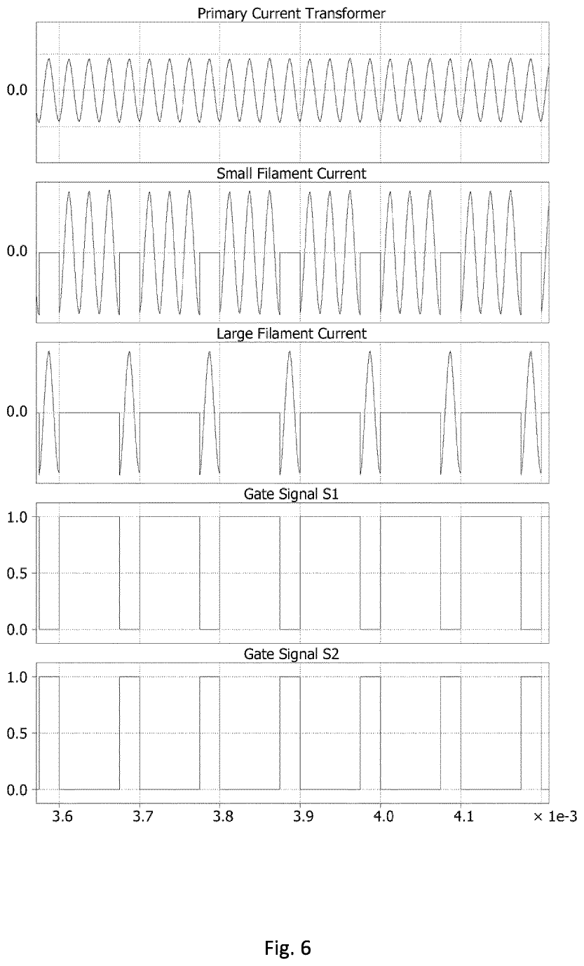

FIG. 6 illustrates an example of the relation between transformer current, respective filament current and respective switch control signal over time. In this example for control of two filaments, a large filament FL and a small filament FS, with two switches S1, S2. The x-axis shows time in milliseconds. As seen in the bottom of the chart, in this example the gate signals for the first switch S1 and the second switch S2 are pulsed control signals, which have a duty cycle of 75% and 25%, respectively. When either of the switches is “ON”, the other is “OFF”. The control of the switches S1, S2, results in a corresponding respective duty cycle controlled filament current for the large filament FL and the small filament SL. The total power over the filaments is regulated with the transformer T1. As shown in the figure, the transformer current is an alternating current with, in this case, constant amplitude and frequency. Similarly to the example described in FIG. 2, the combination of total power over the filaments and the duty cycles determines the effective respective filament currents. For illustration, if the set-point current in this case is 4 A, the effective large filament current is around 3 A and the effective small filament current is around 1 A. The sufficiently large frequency of the pulsed control signals allows the filaments to be kept on a relatively stable temperature, without cooling down too much. It is appreciated that the examples of filament currents, duty cycles, number of filaments etc. are only non-limiting examples for illustration. Many variations are possible to best fit the application at hand.

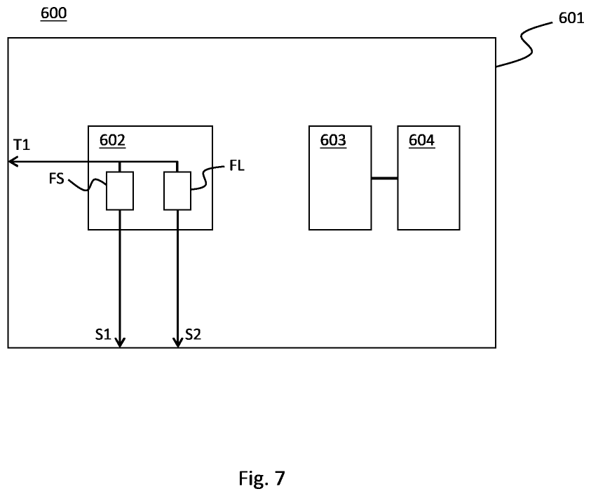

FIG. 7 schematically (no circuit diagram) illustrates an X-ray source insert 600, according to an embodiment of the invention. Such an X-ray source insert 600 may be configured to be included in an X-ray source assembly with a single filament driver FD1 and a control unit CTRL to drive two or more filaments FL, FS. In the example in FIG. 7, the insert 600 is enclosed by a vacuum envelope 601, such that the insert can be sealed under a high vacuum. The vacuum envelope 601 may form e.g. a glass or metal enclosure. The insert comprises a cathode 602 with two or more filaments FL, FS. The filaments are configured to be connected to a filament transformer T1 outside of the insert. The filaments FL, FS are also configured to be connected to their respective switches S1, S2. The example in FIG. 7 illustrates two filaments FS, FL configured to be connected to two switches S1, S2. However, it is also conceivable that the insert 600 comprises three or more filaments, where each Xth filament FX is configured to be connected to a respective switch SX. The insert in FIG. 7 also includes an anode 603. The anode is 603 configured to generate X-rays when impinged with electrons in an electron beam (not shown) emitted from one of the filaments FS, FL at a focal spot on the anode 603. The anode 603 may advantageously be a rotating anode, rotated by a rotor apparatus 604. However, the anode 603 may also be a non-rotating anode for low power applications. In the latter case, not rotor apparatus 604 is required.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and/or by means of a suitably programmed processor. In the device claim enumerating several means, several of these means may be embodied by one and the same item of hardware. Measures recited in mutually different dependent claims may advantageously be used in combination.

### REFERENCE SIGNS

100,200 X-ray source assembly
101, 201 High voltage part
202 Fiber optic connection
301, 401, 402, 501 Fiber optics converter
502 Encoder
600 X-ray source insert
601 Vacuum envelope
602 Cathode
603 Anode
604 Rotor apparatus
C1, C2 Capacitance
CPU Processor
CTRL Control unit
F2 Fiber optics driver
FL, FS, FX Filament
G1 Pulse generator
L1 Inductance
LF, SF, FD1 Filament driver
N1, N2, N3, N4, N5, N6 Gate driver
S1, S2, S3, S4, SX, SH, SL Switch
TL, TS, T1 Transformer

1. An imaging X-ray source assembly with multiple filaments, the X-ray source assembly comprising:
a plurality of filaments configured to emit electrons when a respective current passes through each filament of the plurality of filaments,
a filament transformer configured to transfer electrical energy to the plurality of filaments;
a filament driver configured to supply electrical energy to the plurality of filaments via the filament transformer;
a plurality of switches, each switch being connected to a respective one of the filaments and configured to regulate the respective current through the respective filament; and
a controller connected to the plurality of switches and the filament driver,
wherein the connection between the filament driver and the controller is galvanically isolated,
wherein the filament driver is configured to provide a filament driver output signal to the controller, and
wherein the controller is configured to control the plurality of switches by respective switch control signals based on the filament driver output signal.

2. The X-ray source assembly according to claim 1, wherein the switch control signals are pulsed control signals, and wherein the controller is configured to control each of the switches to switch with a duty cycle larger than 0% and less than 100%.

3. The X-ray source assembly according to claim 2, wherein the controller is configured to control at least one of the plurality of switches to switch with a duty cycle larger than 10% and less than 90%.

4. The X-ray source assembly according to claim 2, wherein the pulsed control signal has a pulse length smaller than a characteristic thermal response time of the respective filament.

5. The X-ray source assembly according to claim 1, wherein the switches are semiconductor switches.

6. The X-ray source assembly according to claim 1, further comprising an anode configured to generate X-rays when impinged with electrons at a focal spot, wherein a first one of the filaments is configured to emit electrons to impinge a first focal spot on the anode, a second one of the filaments is configured to emit electrons to impinge a second focal spot on the anode, and wherein the second focal spot is different from the first focal spot in size, location and/or shape.

7. The X-ray source assembly according to claim 1, wherein the controller is connected to the filament driver via an optical fiber or wireless connection.

8. The X-ray source assembly according to claim 1, wherein power to switch at least one of the switches is derived from windings of the filament transformer.

9. The X-ray source assembly according to claim 1, wherein the X-ray source assembly is programmable to control the respective filament currents.

10-14. (canceled)

15. A computer-implemented method of controlling a plurality of respective filament currents with an X-ray source assembly, the method comprising:
providing a plurality of filaments configured to emit electrons when a respective current passes through each filament of the plurality of filaments;
transferring electrical energy to the plurality of filaments via a filament transformer;
supplying electrical energy, by a filament driver, to the plurality of filaments via the filament transformer;
providing a plurality of switches, each switch being connected to a respective one of the filaments and configured to regulate the respective current through the respective filament; and
providing a controller connected to the plurality of switches and the filament driver, wherein the connection between the filament driver and the controller is galvanically isolated, wherein the filament driver is configured to provide a filament driver output signal to the controller, and wherein the controller is configured to control the plurality of switches by respective switch control signals based on the filament driver output signal.
